(19) United States
(12) Patent Application Publication
(10) Pub. No.: US 2015/0042002 A1
(43) Pub. Date: Feb. 12, 2015

(54) FORMING MACHINE COMPRISING A COMMUNICATION PIPE BETWEEN A COMPENSATION CHAMBER AND A NOZZLE

(71) Applicant: SIDEL PARTICIPATIONS, Octeville Sur Mer (FR)

(72) Inventors: Nicolas Chomel, Octeville sur Mer (FR); Frederic Lecomte, Octeville sur Mer (FR)

(73) Assignee: SIDEL PARTICIPATIONS, Octeville Sur Mer (FR)

(21) Appl. No.: 14/384,746

(22) PCT Filed: Apr. 2, 2013
(86) PCT No.: PCT/EP2013/056869

§ 371 Date: Sep. 12, 2014

(30) Foreign Application Priority Data
Apr. 2, 2012 (FR) 1252972

(51) Int. Cl. B29C 49/78

(52) U.S. Cl. CPC B29C 49/783; B29D 22/003
USPC 264/40.3; 425/149

(57) ABSTRACT

A machine (10) for forming containers made of a thermoplastic material, includes: a mold consisting of two half-molds (12A, 12B) defining a molding cavity (14); a forming pipe (24) which couples the molding cavity (14) to a pressurized-fluid source (26), and which is capable of being closed off by a valve (32); a compensation chamber (34) which is combined with a half-mold (12A); a compensation pipe (40) which couples the compensation chamber (34) to a pressurized-fluid source (26) parallel to the forming pipe (24); and a pipe (44) for bypassing the compensation pipe (40), characterized in that the bypass pipe (44) is coupled to the forming pipe (44) between the valve (32) and the molding cavity (14).

The invention concerns a machine for forming containers made of thermoplastic material, comprising a mold, blowing means and a compensation chamber.

The invention concerns more particularly a machine for forming containers made of thermoplastic material, comprising:
a mold made of at least two half-molds delimiting a molding cavity when their two joint faces are clamped transversely together;
two supports, each of which carries an associated half-mold;
a forming pipe able to connect via a nozzle the neck of a container held in the molding cavity with at least one fluid source at forming pressure;
first controlled sealing means interposed in the forming pipe;
at least one escape pipe connected as a bypass to the forming pipe between the first controlled sealing means and the nozzle;
second controlled sealing means interposed in each escape pipe;
at least one compensation chamber at fluid pressure which is interposed transversely between at least one support and the associated half-mold;
a compensation pipe which connects the compensation chamber to a source of fluid at a working pressure, the compensation pipe being arranged parallel to the forming pipe;
third controlled sealing means interposed in the compensation pipe;
a bypass pipe connected as a bypass to the compensation pipe between the third sealing means and the compensation chamber;
fourth controlled sealing means interposed in the bypass pipe.

Forming machines of this type are already known. A container having its final form, referred to below as a “final container”, is produced by deformation of a container having an initial form, referred to below as a “preform”.

On production of a final container, a preform of heated thermoplastic material is inserted in the molding cavity.

Then a pressurized forming fluid is injected into the preform via the forming pipe. The pressurized fluid pushes the malleable walls of the preform against the cavity walls to give the container its definitive form.

The pressure of the forming fluid tries to push the two half-molds apart. This causes a gap at the joint plane of the two half-molds. The thermoplastic material assumes the imprint of this joint plane, which is reflected in the appearance of a vertical bead protruding along the container.

To avoid the appearance of the imprint of the joint plane, the compensation chamber is pressurized so as to push the half-mold towards the other half-mold against the spacing force. Thus the two half-molds remain joined to each other during the forming operation. The container therefore has no bead line.

For this device to be particularly effective, the compensation chamber must be pressurized before the pressurized forming fluid is injected into the preform via the nozzle.

At the end of the forming operation, the two half-molds must be able to be pushed apart in order to extract the final formed container. To this end, it is preferable for the pressure in the molding cavity to be equal to atmospheric pressure, in order to prevent sudden expansion of the forming fluid. The forming fluid is then evacuated from the final container and the nozzle via an escape pipe.

Also, it is necessary to lower the pressure in the compensation chamber to atmospheric pressure to avoid damaging the machine.

It is known to control the evacuation of the pressurized working fluid after and/or during the evacuation of the forming fluid, and before opening of the mold.

To avoid the mold being opened accidentally before the compensation chamber pressure has returned to atmospheric pressure, a first safety time delay is provided between the evacuation of the working fluid and the opening of the mold.

To avoid the marking of the joint plane on the container, a second safety time delay is provided between evacuation of the forming fluid and evacuation of the working fluid.

However this double safety time delay extends the duration of the forming cycle.

To solve this problem in particular, the invention proposes a machine of the type described above, characterized in that the bypass pipe is connected to the forming pipe between the first sealing means and the nozzle.

According to other characteristics of the machine:
the first and second sealing means are controlled simultaneously between:
   a forming position in which the first sealing means allow communication between the nozzle and the fluid source, the pressure of which provokes a transverse spacing force between the two half-molds, while the second sealing means seal the escape pipe;
   and a relief position in which the first sealing means seal the forming pipe while the second sealing means allow communication between the nozzle and the relief means via the escape pipe;
the first sealing means and the second sealing means are formed by a common valve with at least three ways, called a forming valve;
the third and fourth sealing means are controlled simultaneously between:
   a pressurization position in which the third sealing means allow communication between the compensation chamber and the source of working fluid, in order to push said half-mold against the spacing force, while the fourth sealing means seal the bypass pipe;
   and a bypass position in which the third sealing means seal the compensation pipe while the fourth sealing means allow communication between the compensation chamber and the forming pipe via the bypass pipe;
the third sealing means and the fourth sealing means are formed by a common valve with at least three ways, called a compensation valve;
the working pressure is equal to the forming pressure;
the forming pipe and the compensation pipe are connected to a common source of pressurized fluid;
the relief means comprise a first escape pipe which is connected to atmospheric pressure;
the relief means comprise a second escape pipe which is connected to a device for storing part of the fluid in a reservoir at intermediate pressure between the forming pressure and atmospheric pressure.

The use of such a reservoir advantageously allows recovery of the pressurized blowing fluid for later use. In particular this saves energy by recycling a blowing fluid, the pressure of which is already higher than atmospheric pressure.

The invention also concerns a method for use of the machine produced according to the teaching of the invention, characterized in that the third and fourth sealing means are controlled towards their pressurization position before the first and second sealing means are controlled towards their forming position.

According to other characteristics of the method:
the third and fourth sealing means are controlled towards their bypass position before the first and second sealing means are controlled towards their escape position, such that the fluid pressure in the compensation chamber is balanced with the fluid pressure in the nozzle;
the third and fourth sealing means are controlled towards their bypass position when the pressure inside the nozzle is equal to the forming pressure.

Other characteristics and advantages will appear from reading the detailed description below, for understanding of which reference is made to the attached drawings in which:

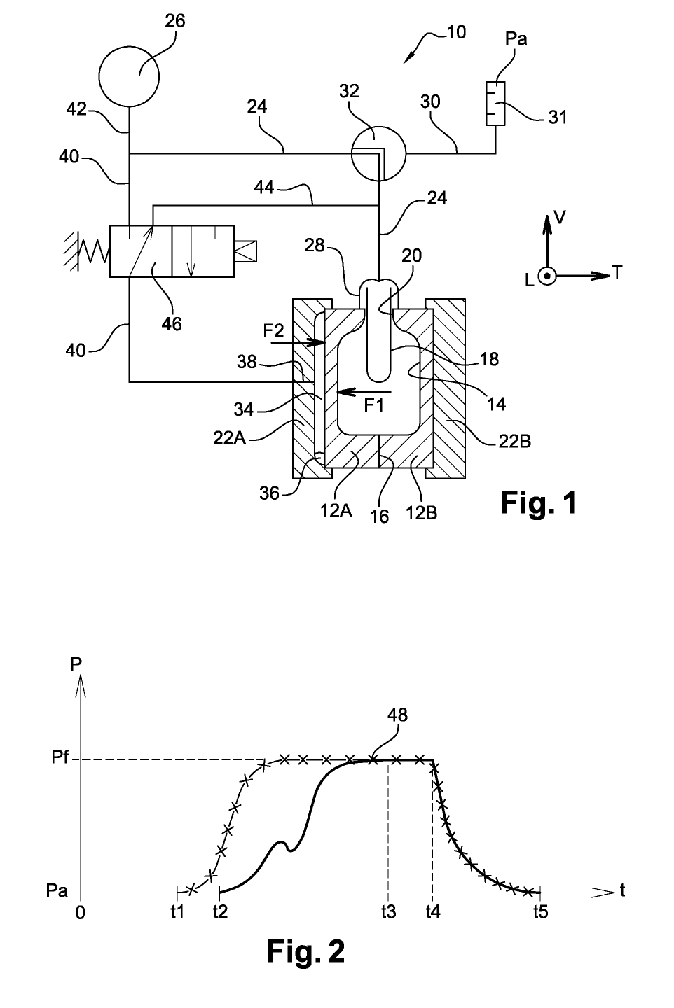

FIG. 1 is a front view showing diagrammatically a molding machine produced according to the teaching of the invention;

FIG. 2 is a diagram which shows in solid lines the development of pressure in the nozzle as a function of time, and in dotted lines the development of pressure in the compensation chamber as a function of time, on the same time scale, when the machine in FIG. 1 is controlled according to a method of the invention.

For the remainder of the description, the orientations longitudinal, vertical and transverse are used in a non-limitative fashion as indicated by the trihedral “L, V, T” in FIG. 1.

For the remainder of the description, elements with an identical structure or similar functions are designated by the same reference numerals.

FIG. 1 shows a machine 10 for forming containers made of thermoplastic material.

The machine 10 comprises a mold 12 made from at least two half-molds 12A, 12B delimiting a molding cavity 14 when their two joint faces are clamped transversely together along the vertical joint plane 16. The body of a preform 18 is held inside the molding cavity 14. An upper orifice 20 is provided at the level of the joint plane, so that the molding cavity 14 communicates with the outside. A neck of the preform 18 protrudes vertically upwards through this orifice.

Each half-mold 12A, 12B is carried by an associated support 22A, 22B. Each support 22A, 22B is arranged transversely against the outer transverse face opposite joint plane 16 of each half-mold 12A, 12B.

For a more detailed description of such a mold assembly 12A, 12B and mold support 22A, 22B, reference is made to document FR-A1-2.659.265.

The invention is applicable in particular to a molding unit as described in document EP-A1-0.821.641. In this document, mold support 22A, 22B is called a “mold carrier”, while each half-mold 12A, 12B is formed from the assembly of a shell on a shell carrier. For more detailed information on this molding unit, reference is made to said document.

A forming pipe 24 is able to connect the molding cavity 14 to at least one source 26 of fluid under a forming pressure “Pf”, for example 40 bar.

According to a variant of the invention (not shown), the forming pipe is also connected to at least one source of fluid at medium pressure. A device (not shown) allows the interior of the preform to be supplied successively with each source at medium pressure, then with the source at high pressure.

The preform is connected in a sealed fashion to the forming pipe 24 via a nozzle 28. Thus the pressure inside the container is substantially equal to the pressure inside the nozzle.

The nozzle 24 here has a bell shape to allow a sealed connection to the preform in the molding cavity 14.

According to a variant of the invention (not shown), the sealed connection between the preform and the nozzle is achieved by inserting the free end of the nozzle in the neck of the preform, the seal being achieved between the cylindrical inner wall of the neck and the nozzle.

The nozzle 28 is here mounted sliding between an upper position in which it is arranged vertically at a distance above the orifice 20 of the mold 12A, 12B, and a lower position in which the nozzle 28 in the form of a bell surrounds the neck of the preform 18 to connect the forming pipe 24 in a sealed fashion to the interior of the preform. This allows injection of the forming fluid at pressure “Pf” into the body of the preform 18 which is inside the molding cavity 14.

An escape pipe 30 is connected as a bypass to the forming pipe 24. The escape pipe 30 is connected to relief means, here formed by an outlet silencer 31 in communication with atmospheric pressure “Pa”.

According to a variant of the invention (not shown), the escape pipe is connected, as well as to the silencer, to means for storing part of the pressurized fluid in a reservoir at an intermediate pressure between the forming pressure “Pf” and atmospheric pressure “Pa”.

According to another variant of the invention (not shown), the machine comprises a second escape pipe which connects as a bypass the forming pipe to a device for storing part of the fluid in a reservoir with intermediate pressure between the forming pressure and atmospheric pressure. The machine is then equipped with a set of valves able to connect the nozzle alternatively to the pressurized fluid source or to the silencer or to the storage means.

Such a storage device advantageously allows saving of energy by recycling the pressurized fluid at each forming cycle. The fluid thus stored can be again compressed at high pressure or used as such as a source of pneumatic energy for other functions of the installation.

The machine 10 comprises means for connecting the nozzle 28 alternatively to the pressurized fluid source 26 or to the escape pipe 30.

To this end, the machine 10 comprises first controlled sealing means interposed in the forming pipe 24 and second controlled sealing means interposed in the escape pipe 30.

The first sealing means are arranged such that the bypass between the escape pipe 30 and the forming pipe 24 is interposed between the first sealing means and the nozzle 28. In other words, the first sealing means are arranged upstream of the bypass of the escape pipe 30 with the forming pipe 24, the term “upstream” referring to a flow of fluid from the source 26 to the nozzle 28.

Each sealing means is able to be controlled selectively between a fully sealed position in which the passage of fluid is prevented, and a fully open position in which the passage of fluid is permitted.

The first sealing means and the second sealing means are here formed by a common three-way valve, called a forming valve 32.

In a non-limitative fashion, in the example shown in FIG. 1, the forming valve 32 is a plug valve.

Nonetheless it is understood that the invention can be used with a gate valve or two independent two-way valves controlled simultaneously.

The forming valve 32 is able to be controlled between:
a forming position as shown in FIG. 1 in which the first sealing means allow communication between the nozzle 28 and the fluid source 26, while the second sealing means fully seal the escape pipe 30;
and a relief position which is obtained by turning the plug of the valve 32 one quarter turn anti-clockwise, in which position the first sealing means fully seal the forming pipe 26 while the second sealing means allow communication between the nozzle 28 and the silencer 31.

When the forming valve 32 is in its forming position, the preform body 18 is deformed by the pressure “Pf” of the forming fluid flowing from the fluid source 26.

When the escape pipe 30 is closed, the pressure rises to the forming pressure “Pf”. When the preform body is shaped to the walls of the molding cavity 14, the pressure “Pf” of the forming fluid provokes a transverse spacing force between the two half-molds 12A, 12B. The spacing force applied to the half-mold 12A shown on the left in FIG. 1 is represented by the arrow “F1”.

The machine also comprises at least one compensation chamber 34 at fluid pressure, which is interposed transversely between the support 22A shown on the left in FIG. 1 and the associated half-mold 12A.

The chamber 34 is closed in a sealed fashion by an elastically deformable joint 36 which allows a transverse deflection of the half-mold 12A in relation to the support 22A without loss of seal.

The support 22A comprises a through orifice 38 which opens into the compensation chamber 34.

A compensation pipe 40 connects the compensation chamber to the source 26 of fluid at working pressure equal to the forming pressure “Pf”. The forming pipe 24 and the compensation pipe 40 are thus connected to a common source of pressurized fluid.

The fluid used here is compressed air.

The compensation pipe 40 is arranged parallel to the forming pipe 24. More particularly, as shown in FIG. 1, a common pipe 42 connects the forming pipe 24 and the compensation pipe 40 to the pressurized fluid source 26.

According to a variant of the invention (not shown), the machine comprises a first source of working fluid and a second separate source of forming fluid.

A bypass pipe 44 is connected as a bypass to the compensation pipe 40. Said bypass pipe 44 is connected to the forming pipe 24 between the forming valve 32 and the nozzle 28.

Third controlled sealing means are interposed in the compensation pipe 40 such that the branch for the bypass pipe 44 is arranged between the third sealing means and the compensation chamber 34.

Fourth controlled sealing means are interposed in the bypass pipe.

Each sealing means is able to be controlled selectively between a fully sealed position in which the passage of fluid is prevented, and a fully open position in which the passage of fluid is permitted.

The third sealing means and fourth sealing means are here formed by a common three-way valve called the compensation valve 46.

The compensation valve 46 shown in FIG. 1 is a gate valve. In a non-!imitative fashion, such a valve is generally called a “3/2 distributor” as it comprises three connection openings and the gate is able to assume two positions.

It is nonetheless understood that the invention can be used with a plug valve or with two independent two-way valves controlled simultaneously.

The compensation valve 46 is controlled alternatively between:
a pressurization position obtained by sliding the gate in FIG. 1 to the left, in which the third sealing means allow communication between the compensation chamber 34 and the source 26 of working fluid, while the fourth sealing means seal the bypass pipe 44;
and a bypass position illustrated in FIG. 1 in which the third sealing means seal the compensation pipe 40 while the fourth sealing means allow communication between the compensation chamber 34 and the forming pipe 24 via the bypass pipe 44.

The gate of the compensation valve 46 is here returned elastically to its bypass position. In particular this avoids the compensation valve 46 remaining blocked in its pressurization position, which would prevent any opening of the mold in case of problems.

In the pressurization position, the pressure “Pf” of the fluid inside the compensation chamber 34 allows the half-mold 12A to be pressed against the spacing force provoked by the fluid in the molding cavity 14.

A method of use of the forming machine 10 is now described with reference to FIG. 2.

At the start of a forming cycle, the forming valve 32 occupies its relief position while the compensation valve 46 occupies its bypass position. Therefore the pressure of the compensation chamber 34 and the pressure in the molding cavity 14 are both equal to atmospheric pressure “Pa”.

A previously heated preform 18 is held in the molding cavity 14 and the nozzle 28 is lowered to its bottom position. Mold 12A, 12B is closed.

At time “t1”, the compensation valve 46 is controlled towards its pressurization position. The compensation chamber 34 is exclusively in communication with the pressurized fluid source 26.

The pressure rises to reach working pressure “Pf” which is here equal to the forming pressure. As a result, a transverse force “F2” is applied to the half-mold 12A to press it against the other half-mold 12B.

When the pressure of the compensation chamber 34 is equal to the forming pressure “Pf” at time “t2”, the forming valve 32 is controlled towards its forming position.

The pressure in the preform body 18 contained in the molding cavity 14 increases until it reaches the forming pressure “Pf”.

The pressure rise inside the body of the preform 18 is regulated by regulation means which are not shown but are well known to the person skilled in the art.

When the preform 18 is shaped to the walls of the molding cavity 14, forming pressure “Pf” is maintained for a specific duration to give the preform 18 its definitive form. The pressure in the molding cavity 14 thus forms a plateau 48 as shown in FIG. 2.

During this plateau 48, the pressure inside the molding cavity 14 is equal to the pressure in the compensation chamber 34.

During this plateau 48, at time “t3”, the compensation valve 46 is controlled towards its bypass position. The compensation chamber 34 is then in direct communication with the pipe 28. Because the pressure “Pf” in the chamber 34 is equal to that in the nozzle 28, no pressure change takes place.

Then at subsequent time “t4”, the forming valve 32 is controlled towards its relief position. The forming fluid contained in the final container and in the nozzle 28 is therefore free to escape through the silencer 31 to the atmosphere. The pressure is thus relieved and the pressure inside the molding cavity 14 falls to reach atmospheric pressure “Pa”.

As the compensation chamber 34 is in direct communication with the nozzle 28, the pressure in chamber 34 falls at the same time as the pressure in the nozzle 28, as shown in FIG. 2.

When the pressure in chamber 34 and in nozzle 28 is equal to atmospheric pressure “Pa”, at time “t5”, the mold 12A, 12B is ready to be opened without difficulty.

Thanks to the machine 10 and its method of use, it is possible to reduce the duration of a forming cycle. The safety time delay necessary for safe opening of the mold 12A, 12B in fact takes place between times “t3” and “t4” when the pressure is still equal to the forming pressure “Pf” in the nozzle 28.

As the compensation chamber 34 is in direct communication with the nozzle 28, this ensures that the pressure in the compensation chamber 34 and the pressure in the nozzle 28 will be equal to atmospheric pressure at the same time.

Also because the compensation chamber 34 can be pressurized an instant before the pressure rise in the nozzle 28 and in the preform, the final container is free from imprint of the joint plane.

1. A machine (10) for forming containers made of thermoplastic material, comprising:
a mold made of at least two half-molds (12A, 12B) delimiting a molding cavity (14) when their two joint faces are clamped transversely together, the molding cavity (14) being intended to receive a container with a neck;
two supports (22A, 22B), each of which carries an associated half-mold (12A, 12B);
a forming pipe (24) able to connect via a nozzle (28) the neck of the container held in the molding cavity (14) to at least one fluid source (26) at a forming pressure (Pf);
first controlled sealing means interposed in the forming pipe (24);
at least one escape pipe (30) connected as a bypass to the forming pipe (24) between the first controlled sealing means and the nozzle (28);
second controlled sealing means interposed in each escape pipe (30);
at least one compensation chamber (34) at fluid pressure which is interposed transversely between at least one support (22A) and the associated half-mold (12A);
a compensation pipe (40) which connects the compensation chamber (34) to a source (26) of fluid at a working pressure, the compensation pipe (40) being arranged parallel to the forming pipe (24);
third controlled sealing means interposed in the compensation pipe (40);
a bypass pipe (44) connected as a bypass to the compensation pipe (40) between the third sealing means and the compensation chamber (34);
fourth controlled sealing means interposed in the bypass pipe (44);
characterized in that the bypass pipe (44) is connected to the forming pipe (24) between the first sealing means and the nozzle (28).

2. The machine (10) as claimed in claim 1, characterized in that the first and second sealing means are controlled simultaneously between:
a forming position in which the first sealing means allow communication between the nozzle (28) and the fluid source (26), the pressure of which provokes a transverse spacing force (F1) between the two half-molds (12A, 12B), while the second sealing means seal the escape pipe (30);
and a relief position in which the first sealing means seal the forming pipe (24) while the second sealing means allow communication between the nozzle (28) and the relief means (31) via the escape pipe (30).

3. The machine (10) as claimed in claim 2, characterized in that the first sealing means and the second sealing means are formed by a common valve (32) with at least three ways, called a forming valve.

4. The machine (10) as claimed in claim 2, characterized in that the third and fourth sealing means are controlled simultaneously between:
a pressurization position in which the third sealing means allow communication between the compensation chamber (34) and the source (26) of working fluid, in order to push said half-mold (12A) against the spacing force, while the fourth sealing means seal the bypass pipe (44);
and a bypass position in which the third sealing means seal the compensation pipe (40) while the fourth sealing means allow communication between the compensation chamber (34) and the forming pipe (24) via the bypass pipe (44).

5. The machine (10) as claimed in claim 4, characterized in that the third sealing means and the fourth sealing means are formed by a common valve (46) with at least three ways, called a compensation valve.

6. The machine (10) as claimed in claim 1, characterized in that the working pressure is equal to the forming pressure (Pf).

7. The machine (10) as claimed in claim 6, characterized in that the forming pipe (24) and the compensation pipe (40) are connected to a common source (26) of pressurized fluid.

8. The machine (10) as claimed in claim 2, characterized in that the relief means (31) comprise a first escape pipe (30) which is connected to atmospheric pressure (Pa).

9. The machine (10) as claimed in claim 8, characterized in that the relief means comprise a second escape pipe which is connected to a device for storing part of the fluid in a reservoir at an intermediate pressure between the forming pressure and atmospheric pressure.

10. A method for use of the machine (10) produced as claimed in claim 1, characterized in that the third and fourth sealing means are controlled towards their pressurization position before the first and second sealing means are controlled towards their forming position.

11. The method as claimed in claim 10, characterized in that the third and fourth sealing means are controlled towards their bypass position before the first and second sealing means are controlled towards their escape position, such that the fluid pressure in the compensation chamber (34) is balanced with the fluid pressure in the nozzle (28).

12. The method as claimed in claim 11, characterized in that the third and fourth sealing means are controlled towards their bypass position when the pressure inside the nozzle (28) is equal to the forming pressure.

13. The machine (10) as claimed in claim 3, characterized in that the third and fourth sealing means are controlled simultaneously between:
a pressurization position in which the third sealing means allow communication between the compensation chamber (34) and the source (26) of working fluid, in order to push said half-mold (12A) against the spacing force, while the fourth sealing means seal the bypass pipe (44);
and a bypass position in which the third sealing means seal the compensation pipe (40) while the fourth sealing means allow communication between the compensation chamber (34) and the forming pipe (24) via the bypass pipe (44).

14. The machine (10) as claimed in claim 13, characterized in that the third sealing means and the fourth sealing means are formed by a common valve (46) with at least three ways, called a compensation valve.
